(19) United States
(12) Patent Application Publication
(10) Pub. No.: US 2025/0008362 A1
(43) Pub. Date: Jan. 2, 2025

(54) CHANNEL STATE INFORMATION REPORTS DURING A SMALL DATA TRANSFER SESSION

(71) Applicant: QUALCOMM Incorporated, San Diego, CA (US)

(72) Inventors: Linhai HE, San Diego, CA (US); Ruiming ZHENG, Beijing (CN); Jing LEI, San Diego, CA (US)

(21) Appl. No.: 18/692,988

(22) PCT Filed: Nov. 19, 2021
(86) PCT No.: PCT/CN2021/131701

§ 371 Date: Mar. 18, 2024

(51) Int. Cl. H04W 24/10; H04W 76/27

(52) U.S. Cl. CPC H04W 24/10; H04W 76/27

(57) ABSTRACT

Various aspects of the present disclosure generally relate to wireless communication. In some aspects, a user equipment (UE) may receive, from a base station, an indication of a set of reference signals for measurement during a small data transfer (SDT) session associated with the UE. Accordingly, the UE may transmit, to the base station and during the SDT session, a channel state information report based at least in part on measuring the set of reference signals during the SDT session. Numerous other aspects are described.

### FIELD OF THE DISCLOSURE

Aspects of the present disclosure generally relate to wireless communication and to techniques and apparatuses for transmitting and receiving channel state information reports during a small data transfer session.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a ser equipment (UE). The apparatus may include a memory and one or more processors coupled to the memory. The one or more processors may be configured to receive, from a base station, an indication of a set of reference signals for measurement during a small data transfer (SDT) session associated with the UE. The one or more processors may be further configured to transmit, to the base station and during the SDT session, a channel state information (CSI) report based at least in part on measuring the set of reference signals during the SDT session.

Some aspects described herein relate to an apparatus for wireless communication at a base station. The apparatus may include a memory and one or more processors coupled to the memory. The one or more processors may be configured to transmit, to a UE, an indication of a set of reference signals for measurement during an SDT session associated with the UE. The one or more processors may be further configured to receive, from the UE and during the SDT session, a CSI report based at least in part on measurements of the set of reference signals performed during the SDT session.

Some aspects described herein relate to a method of wireless communication performed by a UE. The method may include receiving, from a base station, an indication of a set of reference signals for measurement during an SDT session associated with the UE. The method may further include transmitting, to the base station and during the SDT session, a CSI report based at least in part on measuring the set of reference signals during the SDT session.

Some aspects described herein relate to a method of wireless communication performed by a base station. The method may include transmitting, to a UE, an indication of a set of reference signals for measurement during a SDT session associated with the UE. The method may further include receiving, from the ULE and during the SDT session, a CSI report based at least in part on measurements of the set of reference signals performed during the SDT session.

Some aspects described herein relate to a non-transitory computer-readable medium that stores a set of instructions for wireless communication by a UE. The set of instructions, when executed by one or more processors of the UE, may cause the UE to receive, from a base station, an indication of a set of reference signals for measurement during an SDT session associated with the UE. The set of instructions, when executed by one or more processors of the UE, may further cause the UE to transmit, to the base station and during the SDT session, a CSI report based at least in part on measuring the set of reference signals during the SDT session.

Some aspects described herein relate to a non-transitory computer-readable medium that stores a set of instructions for wireless communication by a base station. The set of instructions, when executed by one or more processors of the base station, may cause the base station to transmit, to a UE, an indication of a set of reference signals for measurement during an SDT session associated with the UE. The set of instructions, when executed by one or more processors of the base station, may further cause the base station to receive, from the UE and during the SDT session, a CSI report based at least in part on measurements of the set of reference signals performed during the SDT session.

Some aspects described herein relate to an apparatus for wireless communication. The apparatus may include means for receiving, from a base station, an indication of a set of reference signals for measurement during an SDT session associated with the UE. The apparatus may further include means for transmitting, to the base station and during the SDT session, a CSI report based at least in part on measuring the set of reference signals during the SDT session.

Some aspects described herein relate to an apparatus for wireless communication. The apparatus may include means for transmitting, to a UE, an indication of a set of reference signals for measurement during an SDT session associated with the UE. The apparatus may further include means for receiving, from the UE and during the SDT session, a CSI report based at least in part on measurements of the set of reference signals performed during the SDT session.

Aspects generally include a method, apparatus, system, computer program product, non-transitory computer-readable medium, user equipment, base station, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3, 4, and 5 are diagrams illustrating examples associated with configuring channel state information (CSI) reports during a small data transfer (SDT) session, in accordance with the present disclosure.

FIGS. 6, 7, and 8 are diagrams illustrating examples associated with transmitting and receiving CSI reports during an SDT session, in accordance with the present disclosure.

FIGS. 9 and 10 are diagrams illustrating example processes associated with transmitting and receiving CSI reports during an SDT session, in accordance with the present disclosure.

FIGS. 11 and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

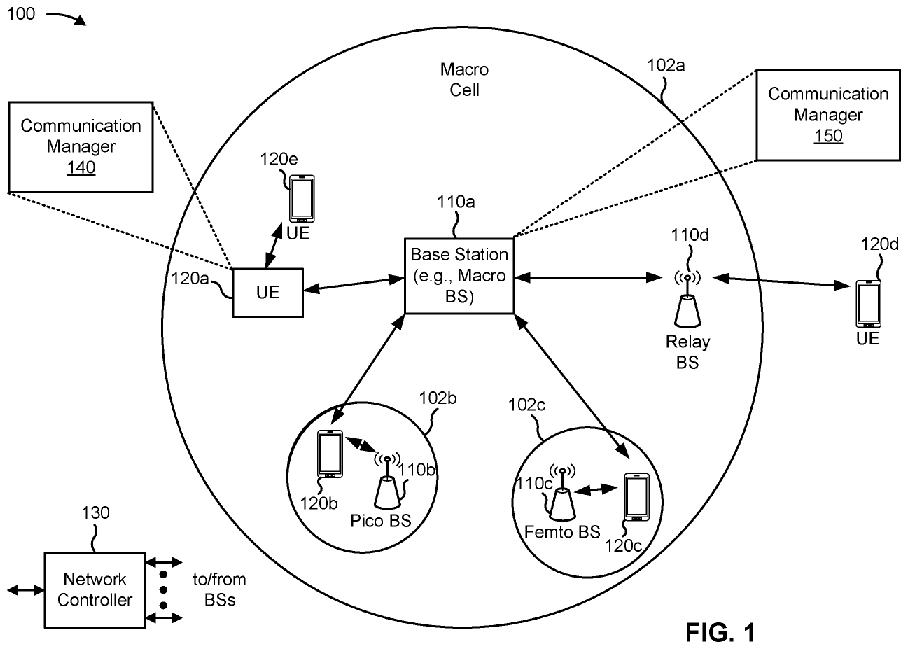

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive (e.g., from the base station 110) an indication of a set of reference signals for measurement during a small data transfer (SDT) session associated with the UE 120 and transmit (e.g., to the base station 110), during the SDT session, a channel state information (CSI) report based at least in part on measuring the set of reference signals during the SDT session. Additionally, or alternatively, the communication manager 140 may perform one or more other operations described herein.

In some aspects, the base station 110 may include a communication manager 150. As described in more detail elsewhere herein, the communication manager 150 may transmit (e.g., to the UE 120) an indication of a set of reference signals for measurement during an SDT session associated with the UE 120 and receive (e.g., from the UE 120), during the SDT session, a CSI report based at least in part on measurements of the set of reference signals performed during the SDT session. Additionally, or alternatively, the communication manager 150 may perform one or more other operations described herein.

As indicated above, FIG. 1 is provided as an example. Other examples may differ from what is described with regard to FIG. 1.

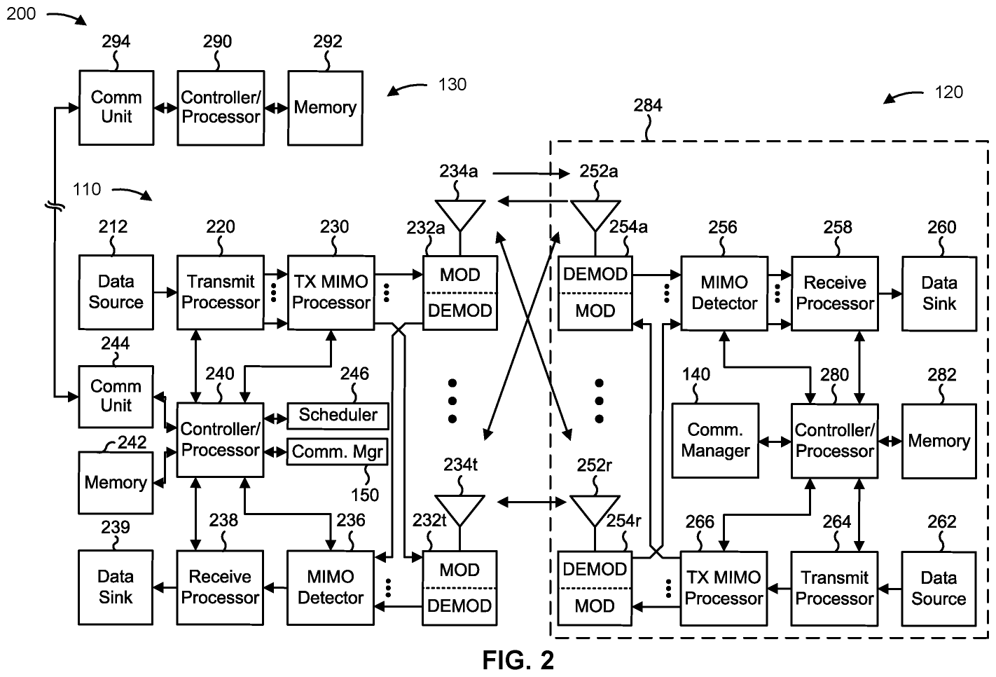

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T>1). The UE 120 may be equipped with a set of antennas 252a through 252r, such as R antennas (R>1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

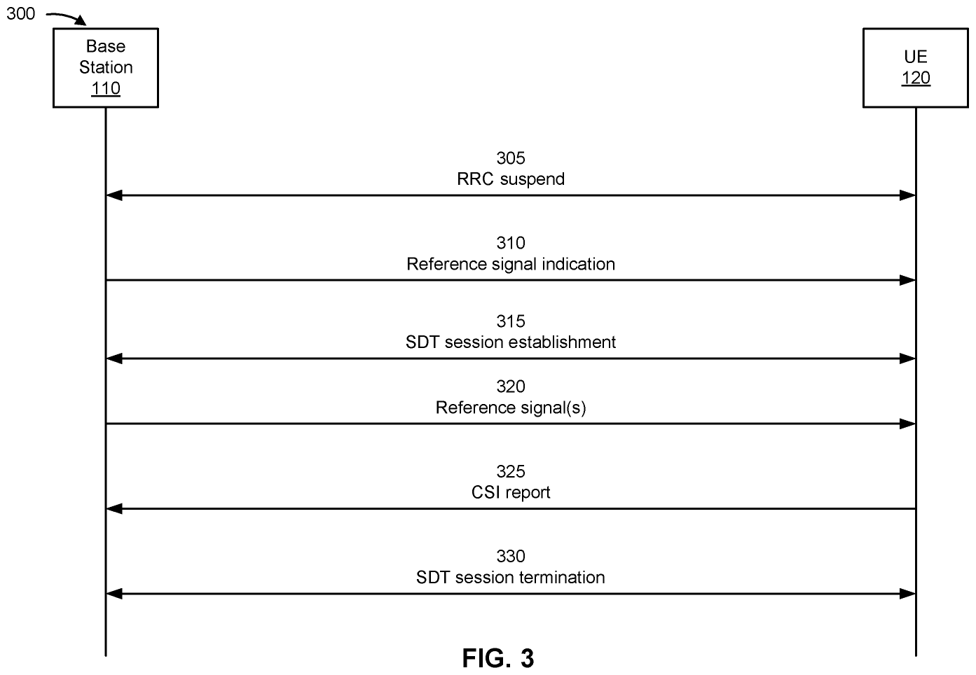

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-12).

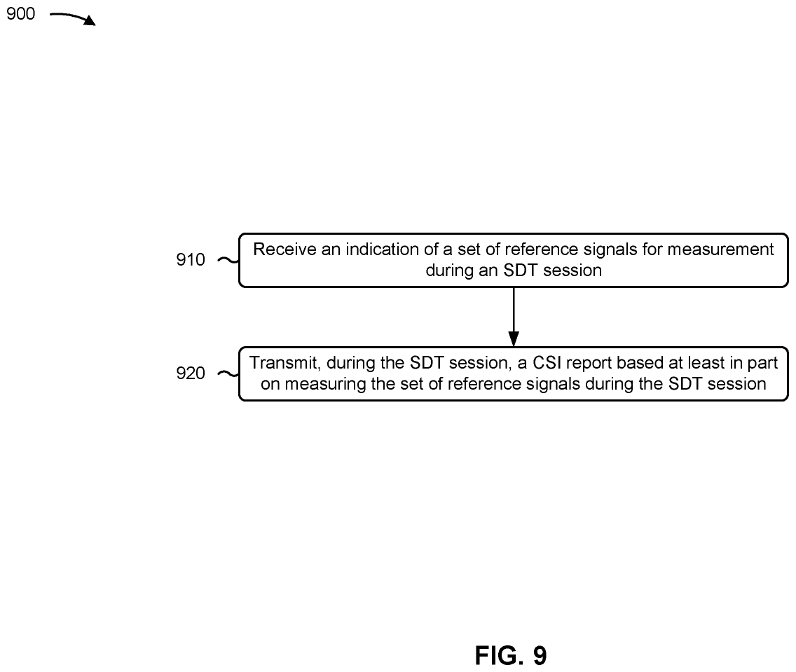

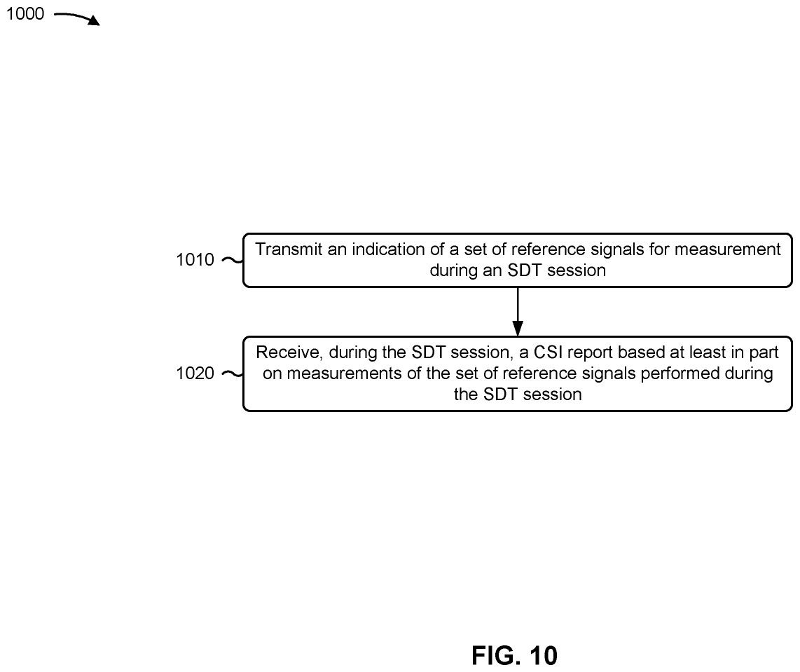

The controller/processor 240 of the base station 110, the controller/processor 280 of the UE 120, and/or any other component(s) of FIG. 2 may perform one or more techniques associated with transmitting and receiving CSI reports during an SDT session, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

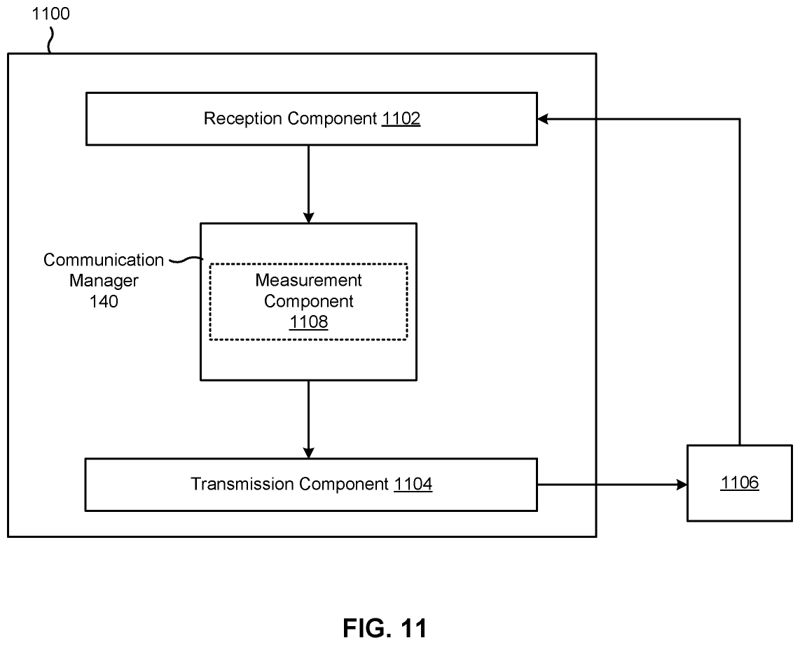

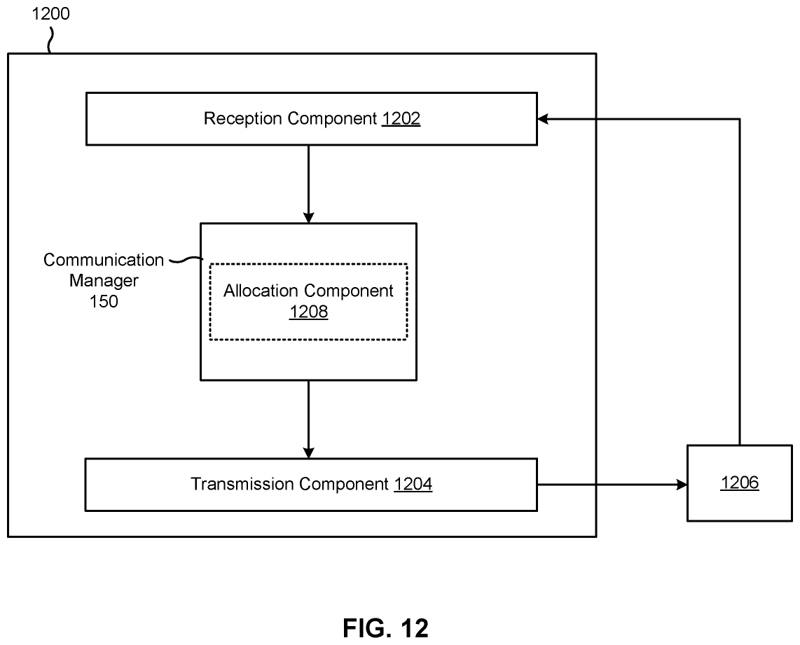

In some aspects, a UE (e.g., the UE 120 and/or apparatus 1100 of FIG. 11) may include means for receiving, from a base station (e.g., the base station 110 and/or apparatus 1200 of FIG. 12), an indication of a set of reference signals for measurement during an SDT session associated with the UE; and/or means for transmitting, to the base station and during the SDT session, a CSI report based at least in part on measuring the set of reference signals during the SDT session. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a base station (e.g., the base station 110 and/or apparatus 1200 of FIG. 12) may include means for transmitting, to a UE (e.g., the UE 120 and/or apparatus 1100 of FIG. 11), an indication of a set of reference signals for measurement during an SDT session associated with the UE; and/or means for receiving, from the UE and during the SDT session, a CSI report based at least in part on measurements of the set of reference signals performed during the SDT session. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A UE may transmit to and receive from a base station when in a radio resource control (RRC) connected mode with a network cell including the base station. However, the UE generally consumes significant amounts of power and processing resources when in the RRC connected mode. Accordingly, the UE may enter an RRC inactive state (e.g., as defined in 3GPP specifications and/or another standard) to conserve power and processing resources.

Some UEs, such as smart devices (such as smart watches and/or fitness trackers, among other examples), industrial sensors, and/or video surveillance devices, among other examples, may have small amounts (e.g., less than 2 megabytes (MB)) of data to exchange with a network. These UEs are sometimes referred to as reduced capacity UEs (“RedCap UEs”) and/or “NR-light UEs.” Accordingly, in order to conserve power and processing resources, a base station may provide an SDT session (e.g., as defined in 3GPP specifications and/or another standard) such that a UE may transmit to and receive from the base station while remaining in an RRC inactivate state.

Some techniques and apparatuses described herein enable a base station (e.g., base station 110) to configure a UE (e.g., UE 120) to perform CSI reporting during an SDT session. For example, the base station 110 may indicate a set of reference signals for the UE 120 to measure during the SDT session. Accordingly, the UE 120 transmits a CSI report based at least in part on measurements of the set of reference signals. As a result, the base station 110 may configure parameters (e.g., an MCS, a transport block (TB) size, and/or another parameter) to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

FIG. 3 is a diagram illustrating an example 300 associated with configuring CSI reports during an SDT session, in accordance with the present disclosure. As shown in FIG. 3, a base station 110 and a UE 120 may communicate with one another (e.g., on a wireless network, such as wireless network 100 of FIG. 1).

As shown by reference number 305, the base station 110 and the UE 120 may suspend an RRC connection. Accordingly, the UE 120 may enter an RRC inactive mode. For example, the base station 110 may transmit, and the UE 120 may receive, an RRCRelease message (e.g., as defined in 3GPP specifications and/or another standard) including a SuspendConfig data structure (e.g., as defined in 3GPP specifications and/or another standard) that indicates at least a paging cycle for the UE 120 and a timer that triggers the UE 120 to perform a periodic radio access network (RAN) based notification area (RNA) update. Although the description herein focuses on the RRCRelease message and the SuspendConfig data structure, the description applies to other, similar messages and data structures.

Additionally, as shown by reference number 310, the base station 110 may transmit, and the UE 120 may receive, an indication of a set of reference signals for measurement during an SDT session associated with the UE 120. In some aspects, the base station 110 transmits, and the UE 120 receives, the indication during an RRC release of the UE 120 from a connected state to an inactive state. Accordingly, the indication may be included in the RRCRelease message described above. Alternatively, the indication may be included in a separate RRC message transmitting before or after the RRCRelease message.

In some aspects, the indication may include one or more NZP-CSI-RS-Resource data structures (e.g., as defined in 3GPP specifications and/or another standard) that indicate one or more CSI-reference signals (RSs) (CSI-RSs) (and/or one or more other reference signals) to measure during the SDT session. Although the description herein focuses on the NZP-CSI-RS-Resource data structure, the description applies to other, similar data structures.

In some aspects, the set of reference signals are associated with a periodicity that is longer than a periodicity associated with another set of reference signals. For example, the set of reference signals may be associated with a period of 640 slots, 320 slots, 160 slots, and so on as compared with a period of 80 slots, 64 slots, 40 slots, 32 slots, and so on for at least one other set of reference signals. As a result, the base station 110 conserves power and processing resources by transmitting the set of reference signals less frequently because the UE 120 is in an RRC inactive state rather than an RRC connected mode.

As shown by reference number 315, the base station 110 and the UE 120 may establish an SDT session. For example, the UE 120 may transmit, and the base station 110 may receive, a request for the SDT session. Accordingly, the base station 110 may transmit, and the ULE 120 may receive, an acceptance of the request. The acceptance may further indicate one or more downlink resources (e.g., in frequency, time, and/or space) to use for the SDT session and/or one or more uplink resources (e.g., in frequency, time, and/or space) to use for the SDT session.

As shown by reference number 320, the base station 110 may transmit the set of reference signals during the SDT session. Accordingly, the UE 120 may measure the set of reference signals. For example, the UE 120 may determine an RSRP parameter, an RSRQ parameter, and/or another LI measurement or higher-layer parameter associated with the set of reference signals. As shown by reference number 325, during the SDT session, the UE 120 may transmit, and the base station 110 may receive, a CSI report based at least in part on measurements of the set of reference signals during the SDT session. As a result, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

Although shown once, in some aspects, the set of reference signals may be transmitted periodically (or at least semi-persistently) by the base station 110 during the SDT session. Accordingly, the UE 120 may measure the set of reference signals periodically and transmit a corresponding CSI report to the base station 110 until the SDT session is complete (e.g., as described below).

As shown by reference number 330, the base station 110 and the UE 120 may terminate the SDT session. For example, the base station 110 may transmit, and the UE 120 may receive, an indication that the SDT session is terminated. In some aspects, the UE 120 may request termination of the session. For example, the UE 120 may transmit, and the base station 110 may receive, a request to terminate the SDT session. As an alternative, the base station 110 may initiate termination of the session (e.g., based on determining that a buffer associated with data intended for the UE 120 is empty and/or based on receiving a buffer status report (BSR) from the UE 120 indicating that there is no additional data intended for the base station 110). As an alternative, the base station 110 may terminate the SDT session based on expiry of a timer associated with the SDT session.

By using techniques as described in connection with FIG. 3, the base station 110 indicates the set of reference signals for the UE 120 to measure during the SDT session. Accordingly, the UE 120 transmits the CSI report based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 3 is provided as an example. Other examples may differ from what is described with respect to FIG. 3.

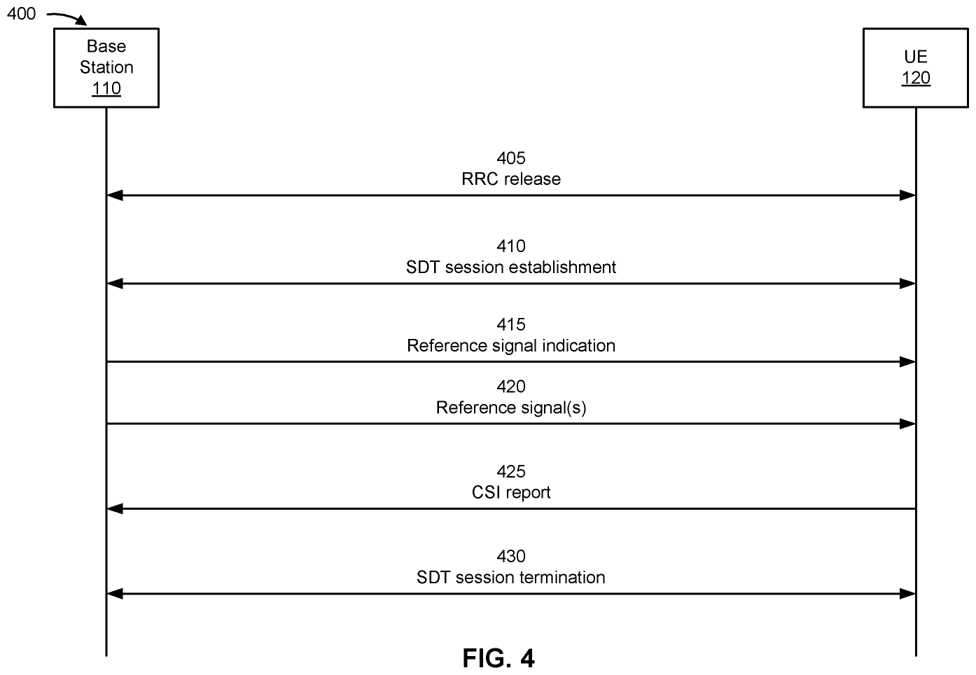

FIG. 4 is a diagram illustrating an example 400 associated with configuring CSI reports during an SDT session, in accordance with the present disclosure. As shown in FIG. 4, a base station 110 and a UE 120 may communicate with one another (e.g., on a wireless network, such as wireless network 100 of FIG. 1).

As shown by reference number 405, the base station 110 and the UE 120 may suspend an RRC connection. For example, the UE 120 may enter an RRC inactive mode as described in connection with FIG. 3.

As shown by reference number 410, the base station 110 and the UE 120 may establish an SDT session. For example, the UE 120 and the base station 110 may establish the SDT session as described in connection with FIG. 3.

Additionally, as shown by reference number 415, the base station 110 may transmit, and the UE 120 may receive, an indication of a set of reference signals for measurement during an SDT session associated with the UE 120. In some aspects, the base station 110 transmits, and the UE 120 receives, the indication using RRC signaling after a start of the SDT session.

As described in connection with FIG. 3, the indication may include one or more NZP-CSI-RS-Resource data structures (e.g., as defined in 3GPP specifications and/or another standard) that indicate one or more CSI-RSs (and/or one or more other reference signals) to measure during the SDT session. In some aspects, and as described in connection with FIG. 3, the set of reference signals are associated with a periodicity that is longer than a periodicity associated with another set of reference signals.

As shown by reference number 420, the base station 110 may transmit the set of reference signals during the SDT session. Accordingly, the UE 120 may measure the set of reference signals as described in connection with FIG. 3. As shown by reference number 425, during the SDT session, the UE 120 may transmit, and the base station 110 may receive, a CSI report based at least in part on measurements of the set of reference signals during the SDT session. As a result, and as described in connection with FIG. 3, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

Although shown once, in some aspects, the set of reference signals may be transmitted periodically (or at least semi-persistently) by the base station 110 during the SDT session. Accordingly, the UE 120 may measure the set of reference signals periodically and transmit a corresponding CSI report to the base station 110 until the SDT session is complete (e.g., as described below).

As shown by reference number 430, the base station 110 and the UE 120 may terminate the SDT session. For example, the UE 120 and the base station 110 may terminate the SDT session as described in connection with FIG. 3.

By using techniques as described in connection with FIG. 4, the base station 110 indicates the set of reference signals for the UE 120 to measure during the SDT session. Accordingly, the UE 120 transmits the CSI report based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 4 is provided as an example. Other examples may differ from what is described with respect to FIG. 4.

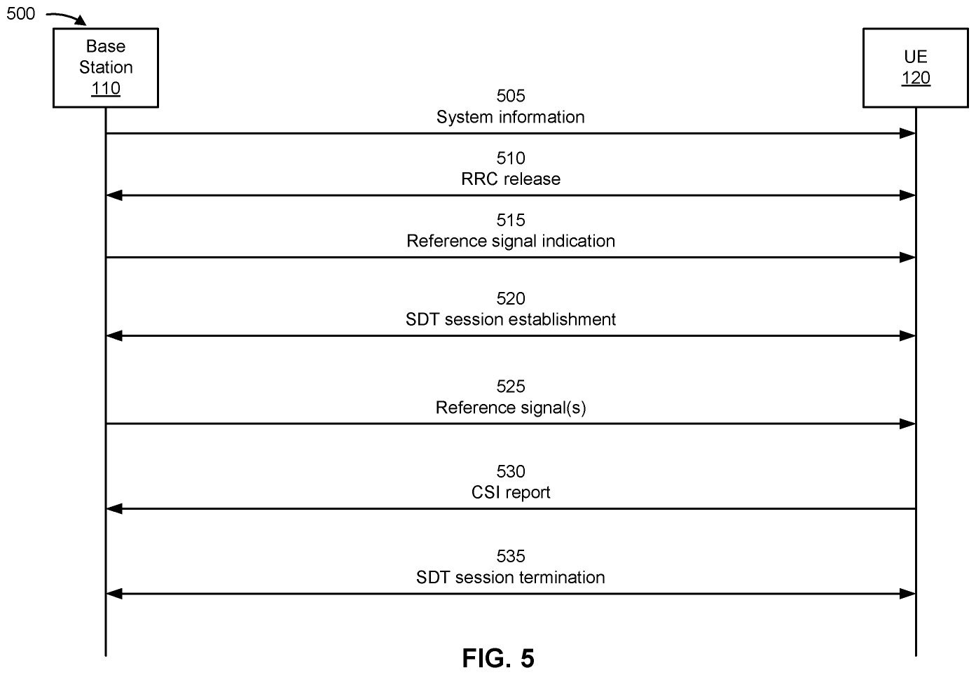

FIG. 5 is a diagram illustrating an example 500 associated with configuring CSI reports during an SDT session, in accordance with the present disclosure. As shown in FIG. 5, a base station 110 and a UE 120 may communicate with one another (e.g., on a wireless network, such as wireless network 100 of FIG. 1).

As shown by reference number 505, the base station 110 may transmit, and the UE 120 may receive, system information (e.g., a system information block (SIB) and/or another similar message) that indicates one or more reference signals. For example, the one or more reference signals may be associated with paging for the UE 120. In some aspects, the one or more reference signals may include a tracking reference signal (TRS), a CSI-RS, or a combination thereof.

As shown by reference number 510, the base station 110 and the UE 120 may suspend an RRC connection. For example, the UE 120 may enter an RRC inactive mode as described in connection with FIG. 3.

Additionally, as shown by reference number 515, the base station 110 may transmit, and the UE 120 may receive, an indication of a set of reference signals for measurement during an SDT session associated with the UE 120. In some aspects, the base station 110 transmits, and the UE 120 receives, the indication during an RRC release of the UE 120 from a connected state to an inactive state. Accordingly, the indication may be included in the RRCRelease message described in connection with FIG. 3. Alternatively, the indication may be included in a separate RRC message transmitting before or after the RRCRelease message.

In some aspects, and as described in connection with FIG. 3, the set of reference signals are associated with a periodicity that is longer than a periodicity associated with another set of reference signals.

In some aspects, indication includes a selection, from the one or more reference signals indicated in the system information, that comprise the set of reference signals. Additionally, in some aspects, the indication may include a same configuration for the one or more reference signals indicated in the system information.

As shown by reference number 520, the base station 110 and the UE 120 may establish an SDT session. For example, the UE 120 and the base station 110 may establish the SDT session as described in connection with FIG. 3.

As shown by reference number 525, the base station 110 may transmit the set of reference signals during the SDT session. Accordingly, the UE 120 may measure the set of reference signals as described in connection with FIG. 3. As shown by reference number 530, during the SDT session, the UE 120 may transmit, and the base station 110 may receive, a CSI report based at least in part on measurements of the set of reference signals during the SDT session. As a result, and as described in connection with FIG. 3, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

In some aspects, the system information may further indicate availability associated with the one or more reference signals. Accordingly, the UE 120 may perform the measurements based on the availability of the set of reference signals. Additionally, or alternatively, the base station 110 may transmit, and the UE 120 may receive (e.g., after transmitting a request for the SDT session), an RRC message indicating availability associated with the one or more reference signals.

Although shown once, in some aspects, the set of reference signals may be transmitted periodically (or at least semi-persistently) by the base station 110 during the SDT session. Accordingly, the UE 120 may measure the set of reference signals periodically and transmit a corresponding CSI report to the base station 110 until the SDT session is complete (e.g., as described below).

As shown by reference number 535, the base station 110 and the UE 120 may terminate the SDT session. For example, the UE 120 and the base station 110 may terminate the SDT session as described in connection with FIG. 3.

By using techniques as described in connection with FIG. 5, the base station 110 indicates the set of reference signals for the UE 120 to measure during the SDT session. Accordingly, the UE 120 transmits the CSI report based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 5 is provided as an example. Other examples may differ from what is described with respect to FIG. 5.

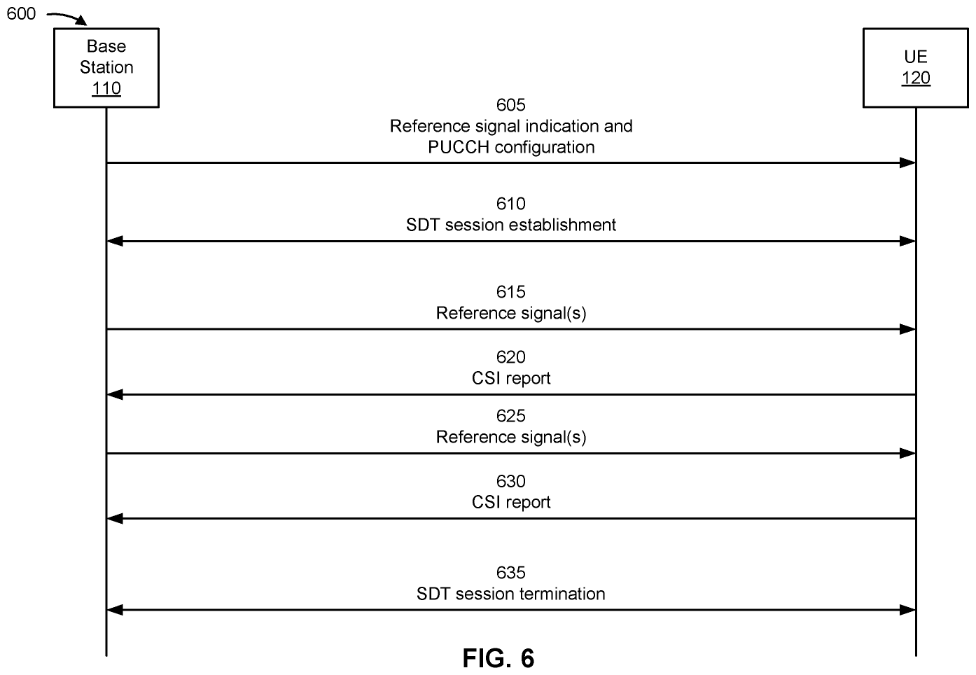

FIG. 6 is a diagram illustrating an example 600 associated with configuring CSI reports during an SDT session, in accordance with the present disclosure. As shown in FIG. 6, a base station 110 and a UE 120 may communicate with one another (e.g., on a wireless network, such as wireless network 100 of FIG. 1).

As shown by reference number 605, the base station 110 may transmit, and the UE 120 may receive, an indication of a set of reference signals for measurement during an SDT session associated with the UE 120. The indication may be transmitting during an RRC release procedure (e.g., as described in connection with FIG. 3) and/or during establishment of an SDT session (e.g., as described in connection with FIG. 4 or FIG. 5). In some aspects, the set of reference signals includes one or more periodic CSI-RSs (P-CSI-RSs).

Additionally with the indication, the base station 110 may transmit, and the UE 120 may receive, an indication of physical uplink shared channel (PUSCH) resources to use for transmitting a periodic CSI (P-CSI) report during the SDT session. For example, the indication may include a frequency domain resource assignment (FDRA) indicator, a time domain resource assignment (TDRA), and/or another data structure indication time, frequency, and/or spatial resources for the PUSCH.

As shown by reference number 610, the base station 110 and the UE 120 may establish an SDT session. For example, the UE 120 and the base station 110 may establish the SDT session as described in connection with FIG. 3.

As shown by reference number 615, the base station 110 may transmit the set of reference signals during the SDT session. Accordingly, the UE 120 may measure the set of reference signals as described in connection with FIG. 3. As shown by reference number 620, during the SDT session, the UE 120 may transmit, and the base station 110 may receive, a CSI report based at least in part on measurements of the set of reference signals during the SDT session. As a result, and as described in connection with FIG. 3, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

Because the set of reference signals include P-CSI-RSs, the base station 110 may transmit the set of reference signals periodically during the SDT session, as shown by reference number 625, until the SDT session is complete. Similarly, the UE 120 may transmit, and the base station 110 may receive, a CSI report periodically based at least in part on measurements of the set of reference signals during the SDT session, as shown by reference number 630, until the SDT session is complete.

As shown by reference number 635, the base station 110 and the UE 120 may terminate the SDT session. For example, the UE 120 and the base station 110 may terminate the SDT session as described in connection with FIG. 3.

By using techniques as described in connection with FIG. 6, the UE 120 transmits the CSI report during the SDT session based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 6 is provided as an example. Other examples may differ from what is described with respect to FIG. 6.

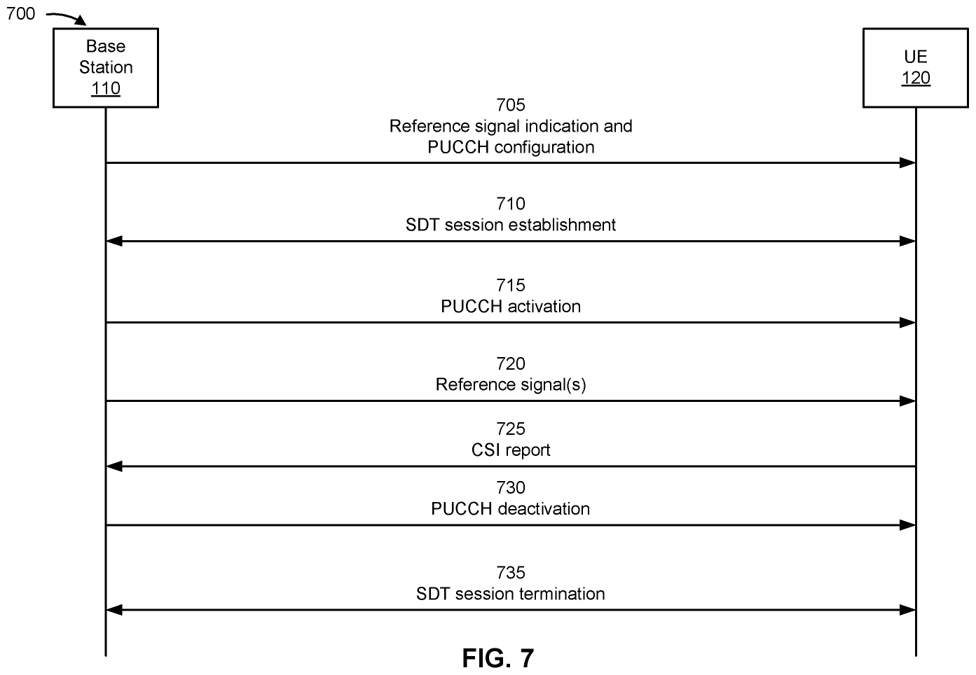

FIG. 7 is a diagram illustrating an example 700 associated with configuring CSI reports during an SDT session, in accordance with the present disclosure. As shown in FIG. 7, a base station 110 and a UE 120 may communicate with one another (e.g., on a wireless network, such as wireless network 100 of FIG. 1).

As shown by reference number 705, the base station 110 may transmit, and the UE 120 may receive, an indication of a set of reference signals for measurement during an SDT session associated with the UE 120. The indication may be transmitting during an RRC release procedure (e.g., as described in connection with FIG. 3) and/or during establishment of an SDT session (e.g., as described in connection with FIG. 4 or FIG. 5). In some aspects, the set of reference signals includes one or more semi-persistent CSI-RSs (SP-CSI-RSs).

Additionally with the indication, the base station 110 may transmit, and the UE 120 may receive, an indication of PUSCH resources to use for transmitting a semi-persistent CSI (SP-CSI) report during the SDT session. For example, the indication may include an FDRA indicator, a TDRA, and/or another data structure indication time, frequency, and/or spatial resources for the PUSCH.

As shown by reference number 710, the base station 110 and the UE 120 may establish an SDT session. For example, the UE 120 and the base station 110 may establish the SDT session as described in connection with FIG. 3.

As shown by reference number 715, the base station 110 may transmit, and the UE 120 may receive, an activation of the PUSCH resources associated with the set of reference signals. For example, the activation may include downlink control information (DCI) and/or another message associated with activation of the PUSCH.

As shown by reference number 720, the base station 110 may transmit the set of reference signals during the SDT session. Accordingly, the UE 120 may measure the set of reference signals as described in connection with FIG. 3. As shown by reference number 725, during the SDT session, the UE 120 may transmit, and the base station 110 may receive, a CSI report based at least in part on measurements of the set of reference signals during the SDT session. As a result, and as described in connection with FIG. 3, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

Because the set of reference signals include SP-CSI-RSs, the base station 110 may transmit the set of reference signals periodically during the SDT session until the SDT session is complete or until the base station 110 deactivates the reference signals (e.g., as described in connection with reference number 730). Similarly, the UE 120 may transmit, and the base station 110 may receive, a CSI report periodically based at least in part on measurements of the set of reference signals during the SDT session until the SDT session is complete or until the base station 110 deactivates the reference signals (e.g., as described in connection with reference number 730).

In some aspects, and as shown by reference number 730, PUSCH base station 110 may transmit, and the UE 120 may receive, a deactivation of the PUSCH resources associated with the set of reference signals. For example, the deactivation may include DCI and/or another message associated with deactivation of the PUSCH. Accordingly, the base station 110 may refrain from transmitting the set of reference signals, and the UE 120 may refrain from transmitting an SP-CSI report, based on the deactivation.

As shown by reference number 735, the base station 110 and the UE 120 may terminate the SDT session. For example, the UE 120 and the base station 110 may terminate the SDT session as described in connection with FIG. 3.

By using techniques as described in connection with FIG. 7, the UE 120 transmits the CSI report during the SDT session based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 7 is provided as an example. Other examples may differ from what is described with respect to FIG. 7.

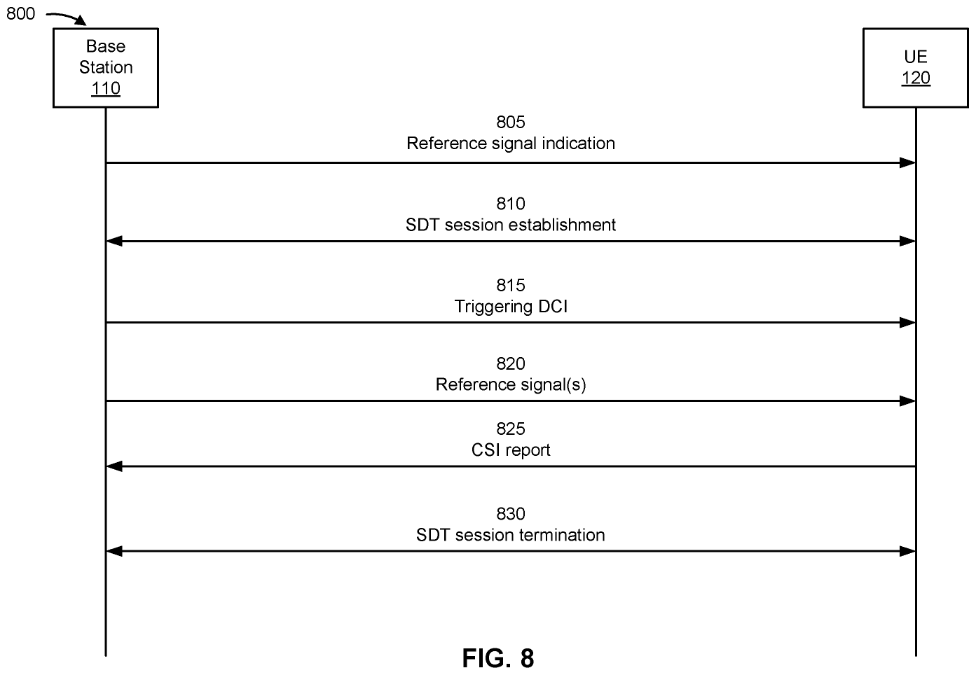

FIG. 8 is a diagram illustrating an example 800 associated with configuring CSI reports during an SDT session, in accordance with the present disclosure. As shown in FIG. 8, a base station 110 and a UE 120 may communicate with one another (e.g., on a wireless network, such as wireless network 100 of FIG. 1).

As shown by reference number 805, the base station 110 may transmit, and the UE 120 may receive, an indication of a set of reference signals for measurement during an SDT session associated with the UE 120. The indication may be transmitting during an RRC release procedure (e.g., as described in connection with FIG. 3) and/or during establishment of an SDT session (e.g., as described in connection with FIG. 4 or FIG. 5). In some aspects, the set of reference signals includes one or more aperiodic CSI-RSs (AP-CSI-RSs).

As shown by reference number 810, the base station 110 and the UE 120 may establish an SDT session. For example, the UE 120 and the base station 110 may establish the SDT session as described in connection with FIG. 3.

As shown by reference number 815, the base station 110 may transmit, and the UE 120 may receive, triggering DCI during the SDT session. For example, the triggering DCI may indicate which reference signal(s), in the set of reference signals, to measure. Additionally, the triggering DCI may indicate PUSCH resources to use for transmitting an aperiodic CSI (AP-CSI) report during the SDT session. For example, the triggering DCI may include an FDRA indicator, a TDRA, and/or another data structure indication time, frequency, and/or spatial resources for the PUSCH.

As shown by reference number 820, the base station 110 may transmit the set of reference signals during the SDT session. Accordingly, the UE 120 may measure the set of reference signals as described in connection with FIG. 3. As shown by reference number 825, during the SDT session, the UE 120 may transmit, and the base station 110 may receive, a CSI report based at least in part on measurements of the set of reference signals during the SDT session. As a result, and as described in connection with FIG. 3, the base station 110 may configure parameters, based on the CSI report, to use for downlink transmissions to the UE 120 and/or uplink transmissions from the UE 120 during the SDT session and/or a future SDT session to improve quality and/or reliability of communications during the SDT session.

As shown by reference number 830, the base station 110 and the UE 120 may terminate the SDT session. For example, the UE 120 and the base station 110 may terminate the SDT session as described in connection with FIG. 3.

By using techniques as described in connection with FIG. 8, the UE 120 transmits the CSI report during the SDT session based at least in part on measurements of the set of reference signals. As a result, the base station 110 may configure parameters to use for downlink transmissions to the UE 120 and/or uplink transmissions from the UE 120 during the SDT session and/or a future SDT session. As a result, the base station 110 and the UE 120 experience increased reliability and/or quality of communications during the SDT session and/or a future SDT session.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the ULE (e.g., UE 120 and/or apparatus 1100 of FIG. 11) performs operations associated with transmitting CSI reports during an SDT session.

As shown in FIG. 9, in some aspects, process 900 may include receiving, from a base station (e.g., base station 110 and/or apparatus 1200 of FIG. 12), an indication of a set of reference signals for measurement during an SDT session associated with the UE (block 910). For example, the UE (e.g., using communication manager 140 and/or reception component 1102, depicted in FIG. 11) may receive, from a base station, an indication of a set of reference signals for measurement during an SDT session associated with the UE, as described herein.

As further shown in FIG. 9, in some aspects, process 900 may include transmitting, to the base station and during the SDT session, a CSI report based at least in part on measuring the set of reference signals during the SDT session (block 920). For example, the UE (e.g., using communication manager 140 and/or transmission component 1104, depicted in FIG. 11) may transmit, to the base station and during the SDT session, a CSI report based at least in part on measuring the set of reference signals during the SDT session, as described herein.

Process 900 may include additional aspects, such as any single aspect or any combination of aspects described below and/or in connection with one or more other processes described elsewhere herein.

In a first aspect, the indication is received during an RRC release of the UE from a connected state to an inactive state.

In a second aspect, alone or in combination with the first aspect, the indication is received using RRC signaling after a start of the SDT session.

In a third aspect, alone or in combination with one or more of the first and second aspects, the set of reference signals are associated with a periodicity that is longer than a periodicity associated with another set of reference signals.

In a fourth aspect, alone or in combination with one or more of the first through third aspects, the set of reference signals include at least one of P-CSI-RSs, SP-CSI-RSs, or AP-CSI-RSs.

In a fifth aspect, alone or in combination with one or more of the first through fourth aspects, the set of reference signals include one or more reference signals indicated in system information.

In a sixth aspect, alone or in combination with one or more of the first through fifth aspects, the indication includes a same configuration for the one or more reference signals indicated in the system information.

In a seventh aspect, alone or in combination with one or more of the first through sixth aspects, the indication includes a selection, from the one or more reference signals indicated in the system information, that include the set of reference signals.

In an eighth aspect, alone or in combination with one or more of the first through seventh aspects, the system information further indicates availability associated with the one or more reference signals.

In a ninth aspect, alone or in combination with one or more of the first through eighth aspects, process 900 further includes receiving (e.g., using communication manager 140 and/or reception component 1102), from the base station and after transmitting a request for the SDT session to the base station, an RRC message indicating availability associated with the one or more reference signals.

In a tenth aspect, alone or in combination with one or more of the first through ninth aspects, process 900 further includes receiving (e.g., using communication manager 140 and/or reception component 1102), from the base station, an indication of PUSCH resources, such that the CSI report is transmitted using the PUSCH resources.

In an eleventh aspect, alone or in combination with one or more of the first through tenth aspects, the CSI report is transmitted periodically until the SDT session is complete.

In a twelfth aspect, alone or in combination with one or more of the first through eleventh aspects, process 900 further includes receiving (e.g., using communication manager 140 and/or reception component 1102), from the base station, an activation of PUSCH resources associated with the set of reference signals, such that the CSI report is transmitted using the PUSCH resources.

In a thirteenth aspect, alone or in combination with one or more of the first through twelfth aspects, the CSI report is transmitted periodically, and process 900 further includes receiving (e.g., using communication manager 140 and/or reception component 1102), from the base station, a deactivation of the PUSCH resources, and refraining from transmitting (e.g., using communication manager 140 and/or transmission component 1104) the CSI report after receiving the deactivation.

In a fourteenth aspect, alone or in combination with one or more of the first through thirteenth aspects, process 900 further includes receiving (e.g., using communication manager 140 and/or reception component 1102), from the base station, triggering DCI during the SDT session, where the indication is included in the triggering DCI.

In a fifteenth aspect, alone or in combination with one or more of the first through fourteenth aspects, the CSI report is transmitted using PUSCH resources indicated in the triggering DCI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110 and/or apparatus 1200 of FIG. 12) performs operations associated with receiving CSI reports during an SDT session.

As shown in FIG. 10, in some aspects, process 1000 may include transmitting, to a UE (e.g., UE 120 and/or apparatus 1100 of FIG. 11), an indication of a set of reference signals for measurement during an SDT session associated with the UE (block 1010). For example, the base station (e.g., using communication manager 150 and/or transmission component 1204, depicted in FIG. 12) may transmit, to a UE, an indication of a set of reference signals for measurement during an SDT session associated with the UE, as described herein.

As further shown in FIG. 10, in some aspects, process 1000 may include receiving, from the ULE and during the SDT session, a CSI report based at least in part on measurements of the set of reference signals performed during the SDT session (block 1020). For example, the base station (e.g., using communication manager 150 and/or reception component 1202, depicted in FIG. 12) may receive, from the UE and during the SDT session, a CSI report based at least in part on measurements of the set of reference signals performed during the SDT session, as described herein.

Process 1000 may include additional aspects, such as any single aspect or any combination of aspects described below and/or in connection with one or more other processes described elsewhere herein.

In a first aspect, the indication is transmitted during an RRC release of the UE from a connected state to an inactive state.

In a second aspect, alone or in combination with the first aspect, the indication is transmitted using RRC signaling after a start of the SDT session.

In a third aspect, alone or in combination with one or more of the first and second aspects, the set of reference signals are associated with a periodicity that is longer than a periodicity associated with another set of reference signals.

In a fourth aspect, alone or in combination with one or more of the first through third aspects, the set of reference signals include at least one of P-CSI-RSs, SP-CSI-RSs, or AP-CSI-RSs.

In a fifth aspect, alone or in combination with one or more of the first through fourth aspects, process 1000 further includes transmitting (e.g., using communication manager 150 and/or transmission component 1204) the set of reference signals after receiving a request for the SDT session from the UE, and refraining from transmitting (e.g., using communication manager 150 and/or transmission component 1204) the set of reference signals after the SDT session is complete.

In a sixth aspect, alone or in combination with one or more of the first through fifth aspects, the set of reference signals include one or more reference signals indicated in system information.

In a seventh aspect, alone or in combination with one or more of the first through sixth aspects, the indication includes a same configuration for the one or more reference signals indicated in the system information.

In an eighth aspect, alone or in combination with one or more of the first through seventh aspects, the indication includes a selection, from the one or more reference signals indicated in the system information, that include the set of reference signals.

In a ninth aspect, alone or in combination with one or more of the first through eighth aspects, the system information further indicates availability associated with the one or more reference signals.

In a tenth aspect, alone or in combination with one or more of the first through ninth aspects, process 1000 further includes transmitting (e.g., using communication manager 150 and/or transmission component 1204), to the UE and after receiving a request for the SDT session from the UE, an RRC message indicating availability associated with the one or more reference signals.

In an eleventh aspect, alone or in combination with one or more of the first through tenth aspects, process 1000 further includes transmitting (e.g., using communication manager 150 and/or transmission component 1204), to the UE, an indication of PUSCH resources, such that the CSI report is received using the PUSCH resources.

In a twelfth aspect, alone or in combination with one or more of the first through eleventh aspects, the CSI report is received periodically until the SDT session is complete.

In a thirteenth aspect, alone or in combination with one or more of the first through twelfth aspects, process 1000 further includes transmitting (e.g., using communication manager 150 and/or transmission component 1204), to the UE, an activation of PUSCH resources associated with the set of reference signals, such that the CSI report is received using the PUSCH resources.

In a fourteenth aspect, alone or in combination with one or more of the first through thirteenth aspects, the CSI report is received periodically, and process 1000 further includes transmitting (e.g., using communication manager 150 and/or transmission component 1204), to the UE, a deactivation of the PUSCH resources, and refraining from transmitting (e.g., using communication manager 150 and/or transmission component 1204) the set of reference signals after transmitting the deactivation.

In a fifteenth aspect, alone or in combination with one or more of the first through fourteenth aspects, process 1000 includes transmitting, to the UE, triggering DCI during the SDT session, where the indication is included in the triggering DCI.

In a sixteenth aspect, alone or in combination with one or more of the first through fifteenth aspects, the CSI report is received using PUSCH resources indicated in the triggering DCI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a measurement component 1108, among other examples.

In some aspects, the apparatus 1100 may be configured to perform one or more operations described herein in connection with FIGS. 3-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

In some aspects, the reception component 1102 may receive (e.g., from a base station, such as apparatus 1106) an indication of a set of reference signals for measurement during an SDT session associated with the apparatus 1100. Accordingly, the measurement component 1108 may measure the set of reference signals during the SDT session. The measurement component 1108 may include one or more antennas, a modem, a demodulator, a MIMO detector, a receive processor, a controller/processor, a memory, or a combination thereof, of the UE described in connection with FIG. 2. Further, the transmission component 1104 may transmit (e.g., to the apparatus 1106), during the SDT session, a CSI report based at least in part on the measurement component 1108 measuring the set of reference signals during the SDT session.

In some aspects, the reception component 1102 may receive, after the transmission component 1104 transmits a request for the SDT session, an RRC message indicating availability associated with the one or more reference signals.

In some aspects, the reception component 1102 may receive an indication of PUSCH resources such that the transmission component 1104 transmits the CSI report using the PUSCH resources. Additionally, in some aspects, the reception component 1102 may receive an activation of the PUSCH resources associated with the set of reference signals. Alternatively, in some aspects, the reception component 1102 may receive triggering DCI during the SDT session that includes the indication of the set of reference signals and indicates the PUSCH resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include an allocation component 1208, among other examples.

In some aspects, the apparatus 1200 may be configured to perform one or more operations described herein in connection with FIGS. 3-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

In some aspects, the transmission component 1204 may transmit (e.g., to a UE, such as apparatus 1206) an indication of a set of reference signals for measurement during an SDT session associated with the UE. Accordingly, the reception component 1202 may receive (e.g., from the apparatus 1206), during the SDT session, a CSI report based at least in part on measurements of the set of reference signals performed during the SDT session.

In some aspects, the transmission component 1204 may transmit the set of reference signals after the reception component 1202 receives a request for the SDT session. Additionally, the transmission component 1204 may refrain from transmitting the set of reference signals after the SDT session is complete.

In some aspects, the transmission component 1204 may transmit, after the reception component 1202 receives a request for the SDT session, an RRC message indicating availability associated with the one or more reference signals.

In some aspects, the transmission component 1204 may transmit an indication of PUSCH resources such that the reception component 1202 receives CSI report using the PUSCH resources. For example, the allocation component 1208 may determine the PUSCH resources to use. The allocation component 1208 may include a MIMO detector, a receive processor, a transmit MIMO processor, a transmit processor, a controller/processor, a memory, or a combination thereof, of the base station described in connection with FIG. 2. Additionally, in some aspects, the transmission component 1204 may transmit an activation of the PUSCH resources associated with the set of reference signals. Alternatively, the transmission component 1204 may transmit triggering DCI during the SDT session that includes the indication of the set of reference signals and indicates the PUSCH resources.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a base station, an indication of a set of reference signals for measurement during a small data transfer (SDT) session associated with the UE; and transmitting, to the base station and during the SDT session, a channel state information (CSI) report based at least in part on measuring the set of reference signals during the SDT session.

Aspect 2: The method of Aspect 1, wherein the indication is received during a radio resource control (RRC) release of the UE from a connected state to an inactive state.

Aspect 3: The method of Aspect 1, wherein the indication is received using radio resource control (RRC) signaling after a start of the SDT session.

Aspect 4: The method of any of Aspects 1 through 3, wherein the set of reference signals are associated with a periodicity that is longer than a periodicity associated with another set of reference signals.

Aspect 5: The method of any of Aspects 1 through 4, wherein the set of reference signals comprise at least one of periodic channel state information reference signals (P-CSI-RSs), semi-persistent CSI-RSs (SP-CSI-RSs), or aperiodic CSI-RSs (AP-CSI-RSs).

Aspect 6: The method of any of Aspects 1 through 5, wherein the set of reference signals comprise one or more reference signals indicated in system information.

Aspect 7: The method of Aspect 6, wherein the indication includes a same configuration for the one or more reference signals indicated in the system information.

Aspect 8: The method of any of Aspects 6 through 7, wherein the indication includes a selection, from the one or more reference signals indicated in the system information, that comprise the set of reference signals.

Aspect 9: The method of any of Aspects 6 through 8, wherein the system information further indicates availability associated with the one or more reference signals.

Aspect 10: The method of any of Aspects 6 through 8, further comprising: receiving, from the base station and after transmitting a request for the SDT session to the base station, a radio resource control (RRC) message indicating availability associated with the one or more reference signals.

Aspect 11: The method of any of Aspects 1 through 10, further comprising: receiving, from the base station, an indication of physical uplink shared channel (PUSCH) resources, wherein the CSI report is transmitted using the PUSCH resources.

Aspect 12: The method of Aspect 11, wherein the CSI report is transmitted periodically until the SDT session is complete.

Aspect 13: The method of any of Aspects 1 through 10, further comprising: receiving, from the base station, an activation of physical uplink shared channel (PUSCH) resources associated with the set of reference signals, wherein the CSI report is transmitted using the PUSCH resources.

Aspect 14: The method of Aspect 13, wherein the CSI report is transmitted periodically, and the method further comprises: receiving, from the base station, a deactivation of the PUSCH resources; and refraining from transmitting the CSI report after receiving the deactivation.

Aspect 15: The method of any of Aspects 1 through 10, further comprising: receiving, from the base station, triggering downlink control information (DCI) during the SDT session, wherein the indication is included in the triggering DCI.

Aspect 16: The method of Aspect 15, wherein the CSI report is transmitted using physical uplink shared channel (PUSCH) resources indicated in the triggering DCI.

Aspect 17: A method of wireless communication performed by abase station, comprising: transmitting, to a user equipment (ULE), an indication of a set of reference signals for measurement during a small data transfer (SDT) session associated with the UE; and receiving, from the UE and during the SDT session, a channel state information (CSI) report based at least in part on measurements of the set of reference signals performed during the SDT session.

Aspect 18: The method of Aspect 17, wherein the indication is transmitted during a radio resource control (RRC) release of the UE from a connected state to an inactive state.

Aspect 19: The method of Aspect 17, wherein the indication is transmitted using radio resource control (RRC) signaling after a start of the SDT session.

Aspect 20: The method of any of Aspects 17 through 19, wherein the set of reference signals are associated with a periodicity that is longer than a periodicity associated with another set of reference signals.

Aspect 21: The method of any of Aspects 17 through 20, wherein the set of reference signals comprise at least one of periodic channel state information reference signals (P-CSI-RSs), semi-persistent CSI-RSs (SP-CSI-RSs), or aperiodic CSI-RSs (AP-CSI-RSs).

Aspect 22: The method of any of Aspects 17 through 21, further comprising: transmitting the set of reference signals after receiving a request for the SDT session from the UE; and refraining from transmitting the set of reference signals after the SDT session is complete.

Aspect 23: The method of any of Aspects 17 through 22, wherein the set of reference signals comprise one or more reference signals indicated in system information.

Aspect 24: The method of Aspect 23, wherein the indication includes a same configuration for the one or more reference signals indicated in the system information.

Aspect 25: The method of any of Aspects 23 through 24, wherein the indication includes a selection, from the one or more reference signals indicated in the system information, that comprise the set of reference signals.

Aspect 26: The method of any of Aspects 23 through 25, wherein the system information further indicates availability associated with the one or more reference signals.

Aspect 27: The method of any of Aspects 23 through 25, further comprising: transmitting, to the UE and after receiving a request for the SDT session from the UE, a radio resource control (RRC) message indicating availability associated with the one or more reference signals.

Aspect 28: The method of any of Aspects 17 through 27, further comprising: transmitting, to the UE, an indication of physical uplink shared channel (PUSCH) resources, wherein the CSI report is received using the PUSCH resources.

Aspect 29: The method of Aspect 28, wherein the CSI report is received periodically until the SDT session is complete.

Aspect 30: The method of any of Aspects 17 through 27, further comprising: transmitting, to the UE, an activation of physical uplink shared channel (PUSCH) resources associated with the set of reference signals, wherein the CSI report is received using the PUSCH resources.

Aspect 31: The method of Aspect 30, wherein the CSI report is received periodically, and the method further comprises: transmitting, to the UE, a deactivation of the PUSCH resources; and refraining from transmitting the set of reference signals after transmitting the deactivation.

Aspect 32: The method of any of Aspects 17 through 27, further comprising: transmitting, to the UE, triggering downlink control information (DCI) during the SDT session, wherein the indication is included in the triggering DCI.

Aspect 33: The method of Aspect 32, wherein the CSI report is received using physical uplink shared channel (PUSCH) resources indicated in the triggering DCI.

Aspect 34: An apparatus for wireless communication at a device, comprising a processor; memory coupled with the processor; and instructions stored in the memory and executable by the processor to cause the apparatus to perform the method of one or more of Aspects 1-16.

Aspect 35: A device for wireless communication, comprising a memory and one or more processors coupled to the memory, the one or more processors configured to perform the method of one or more of Aspects 1-16.

Aspect 36: An apparatus for wireless communication, comprising at least one means for performing the method of one or more of Aspects 1-16.

Aspect 37: A non-transitory computer-readable medium storing code for wireless communication, the code comprising instructions executable by a processor to perform the method of one or more of Aspects 1-16.

Aspect 38: A non-transitory computer-readable medium storing a set of instructions for wireless communication, the set of instructions comprising one or more instructions that, when executed by one or more processors of a device, cause the device to perform the method of one or more of Aspects 1-16.

Aspect 39: An apparatus for wireless communication at a device, comprising a processor; memory coupled with the processor; and instructions stored in the memory and executable by the processor to cause the apparatus to perform the method of one or more of Aspects 17-33.

Aspect 40: A device for wireless communication, comprising a memory and one or more processors coupled to the memory, the one or more processors configured to perform the method of one or more of Aspects 17-33.

Aspect 41: An apparatus for wireless communication, comprising at least one means for performing the method of one or more of Aspects 17-33.

Aspect 42: A non-transitory computer-readable medium storing code for wireless communication, the code comprising instructions executable by a processor to perform the method of one or more of Aspects 17-33.

Aspect 43: A non-transitory computer-readable medium storing a set of instructions for wireless communication, the set of instructions comprising one or more instructions that, when executed by one or more processors of a device, cause the device to perform the method of one or more of Aspects 17-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a base station, an indication of a set of reference signals for measurement during a small data transfer (SDT) session associated with the UE; and
transmit, to the base station and during the SDT session, a channel state information (CSI) report based at least in part on measuring the set of reference signals during the SDT session.

2. The apparatus of claim 1, wherein the indication is received during a radio resource control (RRC) release of the UE from a connected state to an inactive state.

3. The apparatus of claim 1, wherein the indication is received using radio resource control (RRC) signaling after a start of the SDT session.

4. The apparatus of claim 1, wherein the set of reference signals are associated with a periodicity that is longer than a periodicity associated with another set of reference signals.

5. The apparatus of claim 1, wherein the set of reference signals comprise at least one of periodic channel state information reference signals (P-CSI-RSs), semi-persistent CSI-RSs (SP-CSI-RSs), or aperiodic CSI-RSs (AP-CSI-RSs).

6. The apparatus of claim 1, wherein the set of reference signals comprise one or more reference signals indicated in system information.

7. The apparatus of claim 6, wherein the indication includes a same configuration for the one or more reference signals indicated in the system information.

8. The apparatus of claim 6, wherein the indication includes a selection, from the one or more reference signals indicated in the system information, that comprise the set of reference signals.

9. The apparatus of claim 6, wherein the system information further indicates availability associated with the one or more reference signals.

10. The apparatus of claim 6, wherein the one or more processors are further configured to:
receive, from the base station and after transmitting a request for the SDT session to the base station, a radio resource control (RRC) message indicating availability associated with the one or more reference signals.

11. The apparatus of claim 1, wherein the one or more processors are further configured to:
receive, from the base station, an indication of physical uplink shared channel (PUSCH) resources,
wherein the CSI report is transmitted using the PUSCH resources.

12. The apparatus of claim 11, wherein the CSI report is transmitted periodically until the SDT session is complete.

13. The apparatus of claim 1, wherein the one or more processors are further configured to:
receive, from the base station, an activation of physical uplink shared channel (PUSCH) resources associated with the set of reference signals,
wherein the CSI report is transmitted using the PUSCH resources.

14. The apparatus of claim 13, wherein the CSI report is transmitted periodically, and the one or more processors are further configured to:
receive, from the base station, a deactivation of the PUSCH resources; and
refrain from transmitting the CSI report after receiving the deactivation.

15. The apparatus of claim 1, wherein the one or more processors are further configured to:
receive, from the base station, triggering downlink control information (DCI) during the SDT session,
wherein the indication is included in the triggering DCI.

16. The apparatus of claim 15, wherein the CSI report is transmitted using physical uplink shared channel (PUSCH) resources indicated in the triggering DCI.

17. An apparatus for wireless communication at a base station, comprising:
a memory; and
one or more processors, coupled to the memory, configured to:
transmit, to a user equipment (UE), an indication of a set of reference signals for measurement during a small data transfer (SDT) session associated with the UE; and
receive, from the UE and during the SDT session, a channel state information (CSI) report based at least in part on measurements of the set of reference signals performed during the SDT session.

18. The apparatus of claim 17, wherein the indication is transmitted during a radio resource control (RRC) release of the UE from a connected state to an inactive state.

19. The apparatus of claim 17, wherein the indication is transmitted using radio resource control (RRC) signaling after a start of the SDT session.

20. The apparatus of claim 17, wherein the one or more processors are further configured to:
transmit the set of reference signals after receiving a request for the SDT session from the UE; and
refrain from transmitting the set of reference signals after the SDT session is complete.

21. The apparatus of claim 17, wherein the set of reference signals comprise one or more reference signals indicated in system information.

22. The apparatus of claim 21, wherein the indication includes a selection, from the one or more reference signals indicated in the system information, that comprise the set of reference signals.

23. The apparatus of claim 21, wherein the one or more processors are further configured to:
transmit, to the UE and after receiving a request for the SDT session from the UE, a radio resource control (RRC) message indicating availability associated with the one or more reference signals.

24. The apparatus of claim 17, wherein the one or more processors are further configured to:
transmit, to the UE, an indication of physical uplink shared channel (PUSCH) resources,
wherein the CSI report is received using the PUSCH resources.

25. The apparatus of claim 24, wherein the CSI report is received periodically until the SDT session is complete.

26. The apparatus of claim 17, wherein the one or more processors are further configured to:
transmit, to the UE, an activation of physical uplink shared channel (PUSCH) resources associated with the set of reference signals,
wherein the CSI report is received using the PUSCH resources.

27. The apparatus of claim 26, wherein the CSI report is received periodically, and the one or more processors are further configured to:
transmit, to the UE, a deactivation of the PUSCH resources; and
refrain from transmitting the set of reference signals after transmitting the deactivation.

28. The apparatus of claim 17, wherein the one or more processors are further configured to:
transmit, to the UE, triggering downlink control information (DCI) during the SDT session,
wherein the indication is included in the triggering DCI.

29. A method of wireless communication performed by a user equipment (UE), comprising:
receiving, from a base station, an indication of a set of reference signals for measurement during a small data transfer (SDT) session associated with the UE; and
transmitting, to the base station and during the SDT session, a channel state information (CSI) report based at least in part on measuring the set of reference signals during the SDT session.

30. A method of wireless communication performed by a base station, comprising:
transmitting, to a user equipment (UE), an indication of a set of reference signals for measurement during a small data transfer (SDT) session associated with the UE; and
receiving, from the UE and during the SDT session, a channel state information (CSI) report based at least in part on measurements of the set of reference signals performed during the SDT session.
